(19) United States
(12) Patent Application Publication
(10) Pub. No.: US 2011/0184783 A1
(43) Pub. Date: Jul. 28, 2011

(54) Multiple Ranking Methodology for Selecting Part of a Group Based on Combined Multiple Performance and/or Characteristics Criteria

(76) Inventors: Ileana Roman Stoica, Hanover, MN (US); Sorin Roman Stoica, Hanover, MN (US)

(21) Appl. No.: 12/692,632

(22) Filed: Jan. 24, 2010

(51) Int. Cl. G06Q 10/00; G06F 17/30

(52) U.S. Cl. 705/7.38; 707/748; 707/E17.069

(57) ABSTRACT

A methodology for selecting a part of a group of many similar units (i.e. workers as part of a team, retail store locations as part of a store chain, bolts as part of a bolts lot of many similar bolts, etc.), based on the combination of multiple performance and/or characteristics criteria, which includes the following steps: identification of the source group out of which some will be selected, (i.e. team of 25 welders), specification of the exact number of selectees needed (i.e. 12 welders to be laid off), identification and definition of performance criteria to be considered (i.e. productivity, quality, tenure, attendance) and their weights, ranking the entire team by order of each separate criterion and assigning an individual ranking score (i.e. most productive welder will score 1, down to the least productive welder who scores 25), adding the respective ranking scores into an overall score, resorting the list of names by ascending order of the sum of all ranking scores, and selecting the bottom part of the thus obtained ordered list (i.e. bottom 12 welders will be selected for the reduction in workforce).

### BACKGROUND OF THE INVENTION

Whenever a selection of few from a group or class of many needs to be made, the challenge faced by any selector is quite complex:
The selection has to be fair
The selection has to be lawful
The selection criteria have to be relevant
The selection criteria have to be measurable
The selection has to be undisputable
There should be minimal variation in the selection process, from one opportunity to the next, or from one selector to the next. In short, the selection process needs to be reliable and reproducible.

Especially when dealing with people, or business units run by people, some of the challenges described above become paramount—especially those around fairness and variation in the process. An environment fostering doubt and fear of unfair treatment, and riddled with complaints and disputes, stands to lose focus and productivity.

In any disputable selection there is risk for legal exposure, especially in the case of reductions in workforce, or performance management (including, but not limited to, compensation).

There is also a time waste component to selections associated with disputable or high variation practices. This time waste is associated with all the back-and-forth happening whenever there is absence of structure in a complex operational process.

### SUMMARY OF THE INVENTION

This methodology allows the complex challenges of any selector to be addresses, in a simple, straight-forward, data driven manner. It also brings the possibility of the “blind” approach, very useful in any people-related selections. To best illustrate this methodology, we will use an example involving people—the most likely selection to lead to complaints, disputes, etc—if conducted improperly. Well select the 12 welders to be laid off, from a team of 25 welders.

This methodology for selecting a part of a group of many similar units (i.e. team of 25 welders), based on the combination of multiple performance and/or characteristics criteria, includes the following steps:
identification of the source group out of which some will be selected, (i.e. team of 25 welders),
specification of the exact number of selectees needed, and reason (i.e. 12 welders to be laid off),
identification and definition of performance criteria to be considered (i.e. productivity, quality, tenure, attendance) and their weights,
ranking the entire team by order of each separate criterion and assigning an individual ranking score (i.e. most productive welder will score 1, down to the least productive welder who scores 25),
applying the weighting factor—if applicable,
adding the respective ranking scores into an overall score,
resorting the list of names by ascending order of the sum of all ranking scores,
selecting the bottom part of the thus obtained ordered list (i.e. bottom 12 welders will be selected for the reduction in workforce).

The identification and definition of performance criteria to be considered (i.e. productivity, quality, tenure, attendance) and their weights should be carefully approached from the perspective of relevance, as defined by the organizational goals. For example, an organization striving to reach 99.999% quality will assign a higher weight to a quality score. A company struggling to survive might consider more important to get as many units produced per hour as possible, therefore assigning productivity as their leading criterion.

Let's select the criteria for our example: productivity, quality, and attendance, all equally weighted. FIG. 01 shows all welders, identified by employee ID rather than name, listed with their individual productivity results. These results, to better reflect performance and eliminate potential special causes (sick time, meetings, etc.), are average monthly results based on three months worth of data.

FIG. 02 shows the welders with their ranking score by productivity. The higher the productivity—expressed in units per day, the higher their position in the prioritized list—therefore, the lower the ranking score. The reason for the selection has to be correlated with the ranking order: the lowest performing are selected for layoffs, while for raises we would select the highest performing ones.

In case of a tie—as shown in the highlighted rows—for equal results we assign equal ranking, and skip one or more spots. More precisely, three workers tie at 19 units per day; they all receive rank 11 but ranks 12 and 13 do not exist anymore.

FIG. 03 shows the welders with their ranking score by quality. The higher their quality, the higher their position in the prioritized list—therefore, the lower the ranking score.

FIG. 04 shows the welders with their ranking score by attendance, expressed as minutes of lateness per month. The lower their lateness, the higher their position in the prioritized list—therefore, the lower the ranking score.

FIG. 05 shows the workers and their total ranking score, calculated as a simple sum of all the other raking scores: productivity, quality, and attendance, all these criteria having equal weight in the decision. The 12 lowest scoring employees are highlighted in grey, showing that they are on the layoff list, based on these criteria. There are a few ties in the total ranking score; however these do not alter or impact the decision in this case. Should the case have been different, for instance the two employees with the total ranking score of 40—highlighted in yellow—falling one above and one below the cut-off line, then further criteria needs to be applied—tenure, for example—or weighting should be applied to the existing criteria.

In FIG. 06 we are applying weighting to the selection criteria. Since we are selecting employees for a layoff, we are using productivity as the highest weighting criterion, at 60%. Quality comes second, at 30%. Finally, attendance comes third, at only 10%. Applying these weight factors in calculating the total ranking score will reveal the weighted ranking of our employee list. The total ranking formula becomes:

Total Ranking=Productivity Ranking*60%+Quality Ranking*30%++Attendance Ranking*10%

The welders that had been selected under the equal-weight criteria are marked with “x” in the left column. Although few, some will no longer be selected under weighted criteria, due to the high weight assigned to productivity, and their high performance in this area. For these employees, attendance and quality no longer puts them on the layoff list.

By applying this methodology, selecting items form a group or class of many is no longer a challenge, regardless of scope or field of application.

### BRIEF DESCRIPTION OF THE DRAWINGS

FIG. 01.: Employees by monthly average productivity results

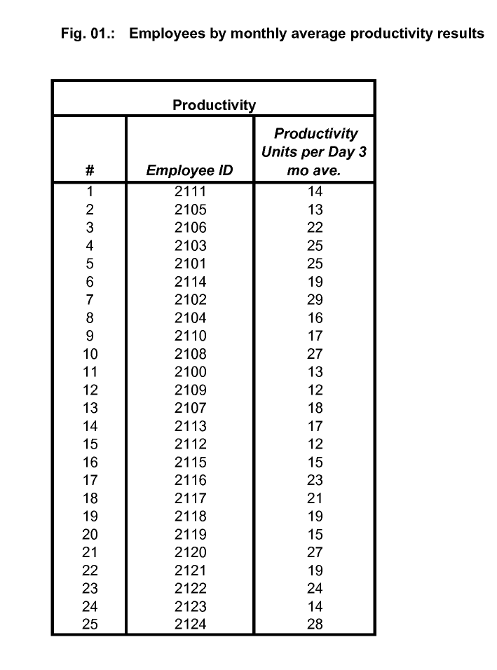

FIG. 02: Employees listed with their productivity ranking

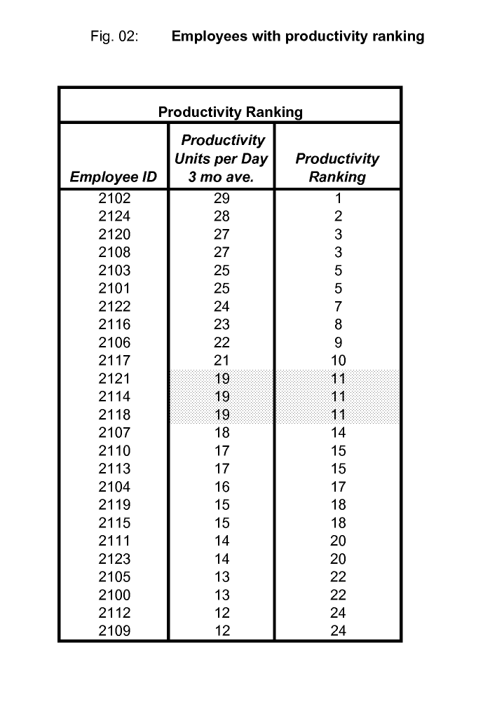

FIG. 03: Employees listed with their quality ranking

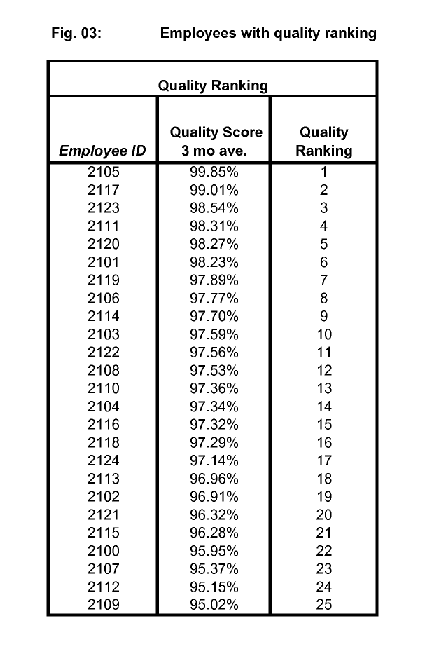

FIG. 04: Employees listed with their attendance ranking

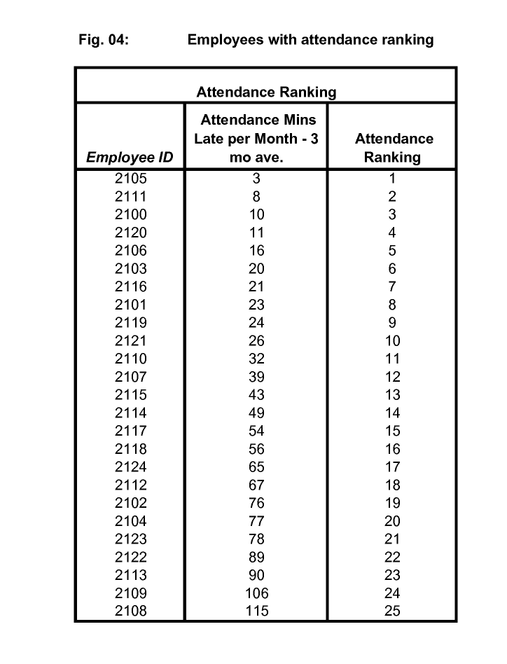

FIG. 05: Employees with all criteria ranking, showing cut-off line above the 12th lowest ranked employee

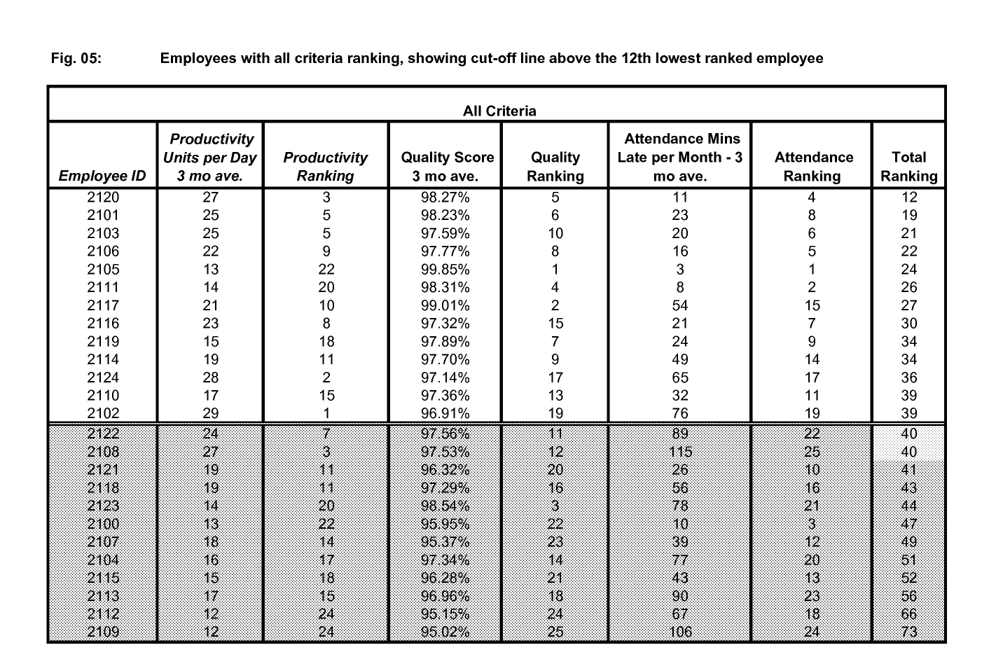

FIG. 06: Employees with weighted criteria ranking, showing cut-off line above the 12th lowest ranked employee

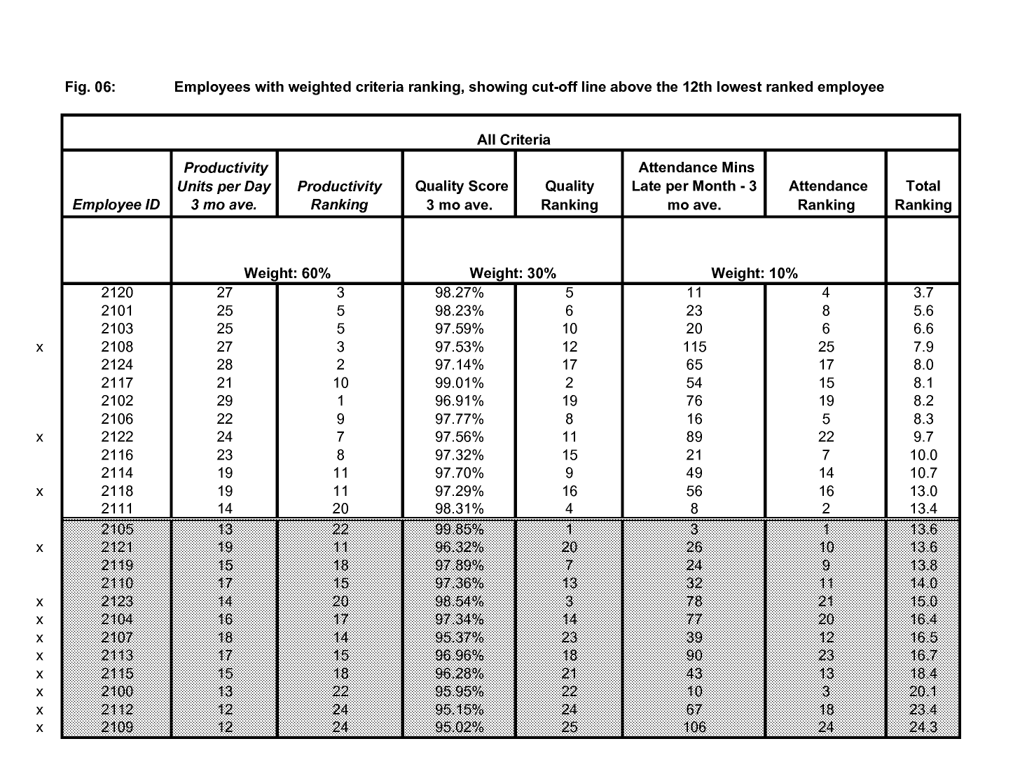

1. A methodology for selecting a part of a group of many similar units (i.e. workers as part of a team, retail store locations as part of a store chain, bolts as part of a bolts lot of many similar bolts, etc.), based on the combination of multiple (more than one) performance and/or characteristics criteria, said methodology comprising: identification of the source group out of which some will be selected, (i.e. team of 25 welders), specification of the exact number of selectees needed (i.e. 12 welders to be laid off), identification and definition of performance criteria to be considered (i.e. productivity, quality, tenure, attendance) and their weights, ranking the entire team by order of each separate criterion and assigning an individual ranking score (i.e. most productive welder will score 1, down to the least productive welder who scores 25), adding the respective ranking scores into an overall score, resorting the list of names by ascending order of the sum of all ranking scores, and selecting the bottom part of the thus obtained ordered list (i.e. bottom 12 welders as ones selected for reduction in workforce).

2. The methodology of claim 1, wherein all the performance criteria could have equal weighting (i.e. four different criteria, each weighting 25% of the total).

3. The methodology of claim 1, wherein the performance criteria could have different, yet clearly defined weighting.

4. The methodology of claim 1, wherein the top performers of the group are selected.

5. The methodology of claim 1, wherein the bottom performers of the group are selected.

6. The methodology of claim 1, wherein the characteristics used as criteria for selection can be appearance, descriptive, or qualitative features (i.e. color, size, hardness, etc)

7. The methodology of claim 1, wherein the criteria for selection is specifically designed for each selection process.

8. The methodology of claim 1, wherein the units that comprise the group are identified by name, code, serial number, physical description, feature, or any other identification method.

9. The methodology of claim 1, wherein the resorting of the list of names or unit identifiers is done by descending order of the sum of all ranking scores.

10. The methodology of claim 1, wherein the units to be selected out of a group of many similar units are people or other living beings (i.e. sniffing dogs).

11. The methodology of claim 1, wherein the units to be selected out of a group of many similar units are production, organizational, or business units.

12. The methodology of claim 1, wherein the units to be selected out of a group of many similar units are methodologies, processes, or concepts.

13. The methodology of claim 1, wherein the units to be selected out of a group of many similar units are software, applications, system units, or combinations of the above.

14. The methodology of claim 1, wherein the units to be selected out of a group of many similar units are technology or hardware units.

15. The methodology of claim 1, wherein the units to be selected out of a group of many similar units are physical objects.

16. The methodology of claim 1, wherein the units to be selected out of a group of many similar units are phenomena or events.

17. A computerized or automated system using an application for the implementation, documentation, and management of a methodology for selecting a part of a group of many similar units (i.e. workers as part of a team, retail store locations as part of a store chain, bolts as part of a bolts lot of many similar bolts, etc.), based on the combination of multiple performance criteria, said methodology comprising: identification of the source group out of which some will be selected, (i.e. team of 25 welders), specification of the exact number of selectees needed (i.e. 12 welders to be laid off), identification and definition of performance criteria to be considered (i.e. productivity, quality, tenure, attendance), ranking the entire team by order of each separate criterion and assigning an individual ranking score (i.e. most productive welder will score 1, down to the least productive welder who scores 25), adding the respective ranks into an overall score, resorting the list of names by ascending order of the sum of all ranking scores, and selecting the bottom part of the thus obtained ordered list (i.e. bottom 12 welders as ones selected for reduction in workforce).

18. The system of claim 17 further comprising one or more computers configured to prompt a user to select at least one member of a group of multiple similar units.

19. The system of claim 17 further comprising the functionality of management, tracking, documentation and archiving of performance indicators for said units.

20. The system of claim 17 further comprising the functionality of performance management (including compensation), based on performance indicators for said units.
